(19) United States
(12) Patent Application Publication
(10) Pub. No.: US 2022/0270485 A1
(43) Pub. Date: Aug. 25, 2022

(54) VEHICLE PROXIMITY WIRELESS MONITORING SYSTEM

(71) Applicant: SAFE FLEET ACQUISITION CORP., Belton, MI (US)

(72) Inventors: Eric Combs, Shoreham, NY (US); Justin Garver, Osceola, IN (US); Stephen Hunter, Gladwin, MI (US); L. Allan McGuire, Elkhart, IN (US); Richard Tier, Boca Raton, FL (US)

(73) Assignee: SAFE FLEET ACQUISITION CORP., Belton, MI (US)

(21) Appl. No.: 17/689,001

(22) Filed: Mar. 8, 2022

Related U.S. Application Data
(63) Continuation of application No. PCT/US2020/050765, filed on Sep. 14, 2020.
(60) Provisional application No. 62/900,360, filed on Sep. 13, 2019.

(51) Int. Cl. G08G 1/16; H04L 12/40

(52) U.S. Cl. CPC G08G 1/16; H04L 12/40006; H04L 2012/40215; H04L 2012/40273

(57) ABSTRACT

A vehicle proximity monitoring system includes an operator area portion comprising a computer processor programmed for receiving and processing both wireless-based data communications and wire-based data communications. A proximity detection portion of the monitoring system may include a condition monitoring device and associated components for wirelessly transmitting data collected by the condition monitoring device to the operator area portion. The proximity detection portion may be configured for communication with a controller area network (CAN) bus operatively associated with the vehicle, and a power line of the vehicle for pairing at least one component of the proximity detection portion with at least one component of the operator area portion.

### CROSS-REFERENCE TO RELATED APPLICATIONS/PRIORITY CLAIM

The present continuation application claims the priority benefit of PCT Application No. PCT/US2020/050765, filed on Sep. 14, 2020, which claims the benefit of U.S. Provisional Patent Application Ser. No. 62/900,360, filed on Sep. 13, 2019, and the entirety of these priority applications are incorporated by reference herein.

### FIELD OF THE INVENTION

Various embodiments of the present invention generally relate to systems and techniques for monitoring activity in the environment around a vehicle, especially when the vehicle is in motion. In particular embodiments, the invention may involve using a camera-based wireless monitoring system for identifying obstacles and other hazards in the vicinity of a tractor-trailer type vehicle.

### BACKGROUND

Commercial-scale vehicles are essential for shipping and delivering a wide variety of products and materials to consumers at different destinations, for assisting with construction and infrastructure maintenance projects, and for agricultural activity, among many other uses. They are a key component of any successful economy.

However, commercial-scale vehicles can be cumbersome and challenging to navigate and position in different locations. For example, vehicles that include a tractor-trailer type arrangement can be challenging to maneuver around corners and to move in reverse. Accordingly, tractor-trailer vehicles suffer from accidents caused by backing up the vehicle, sometimes during the process of approaching the loading dock of a customer warehouse where goods are being delivered, for example. The likelihood and severity of such accidents can be compounded by factors such as driver inexperience, challenging back-up requirements at the delivery location, and high-stress situations involving heavy pedestrian presence, among other factors which complicate the vehicle movement process.

Therefore, enhanced tools and techniques are needed that can alleviate the problems associated with moving tractor-trailer vehicles, for example, and other commercial-scale vehicles. In particular, technology is needed that can assist with monitoring and awareness of the environment surrounding a vehicle when turning, backing up, or otherwise maneuvering the vehicle.

### SUMMARY

In certain non-limiting aspects of the present invention, a vehicle proximity monitoring system is provided. The monitoring system may include an operator area portion comprising a computer processor programmed for receiving and processing both wireless-based data communications and wire-based data communications. Also, a proximity detection portion of the monitoring system may comprise at least one condition monitoring device, an antenna for wireles sly transmitting data collected by the condition monitoring device to the operator area portion, and the proximity detection portion be configured for data communication with: a controller area network (CAN) bus operatively associated with the vehicle, and a power line of the vehicle for pairing at least one component of the proximity detection portion with at least one component of the operator area portion.

In other non-limiting aspects of the invention, the operator area portion further comprises at least one display for displaying data communicated from the condition monitoring device. The condition monitoring device may comprise at least one camera programmed for generating video data associated with a proximity of the vehicle, at least one sensor programmed for generating data associated with a proximity of the vehicle, and/or the sensor may programmed for using at least one of, or a combination of, sonar, radar, or lidar for generating data associated with a proximity of the vehicle.

In other non-limiting aspects of the invention, the vehicle may include a tractor-trailer combination, or a tractor and multiple trailers. The proximity detection portion of the monitoring system may be positioned on the trailer most distally located from the operator area portion, or one or more additional monitoring systems may be operatively associated with at least one of the multiple trailers.

In certain non-limiting aspects of the invention, an adapter may be configured for establishing at least one data communication connection between at least one receptacle of the vehicle and the proximity detection portion. The adapter may be configured for interfacing the proximity detection portion with at least one data communication function and/or power function of the vehicle. In other aspects, a patch antenna may be configured and used to boost a signal wirelessly communicated by the proximity detection portion to the operator area portion. The operator area portion may include a data storage medium for storing event data associated with data received from the condition monitoring device.

In other non-limiting aspects of the invention, the operator area portion can be configured for wirelessly pairing with the proximity detection portion, or pairing via the CAN bus connection. The proximity detection portion may be configured for connecting to a global positioning system and/or an electronic control unit of the vehicle via the CAN bus connection. The operator area portion may include a display for displaying data communicated from the condition monitoring device which is enabled by connecting to the display via the CAN bus connection.

In certain non-limiting aspects of the invention, a communication system can be provided for wireless-enabled devices. In one example, the system may include a first wireless-enabled device; and at least a second wireless-enable devices configured for data connectivity with the first wireless-enable device through different connections. These connections may include a wireless-based data communication connection, and a wire-based data communication connection through a controller area network (CAN) bus. The CAN bus may be operatively associated with a vehicle.

### BRIEF DESCRIPTION OF THE FIGURES

FIG. 1 schematically illustrates an implementation architecture for certain aspects of proximity monitoring systems structured in accordance with certain embodiments of the present invention.

FIG. 2 includes an example of a proximity monitoring system installed in a vehicle.

FIG. 3 depicts an example of a receptacle associated with a trailer for facilitating power and data communication functions.

FIG. 4 schematically illustrates a vehicle trailer indicating multiple potential locations for sensor or camera placement.

FIG. 5 provides an example of a process flow for installing or configuring the vehicle proximity monitoring system for operation in association with a vehicle.

FIGS. 6 through 11 illustrate various views of an example of an adapter which can be used to interface a proximity monitoring system with certain vehicle systems.

FIG. 12 schematically illustrates an example of certain aspects of creating a connection between a proximity monitoring system and a CAN bus of a vehicle.

FIG. 13 includes an example of creating connectivity between and among certain wireless-enable devices in accordance with certain aspects of the invention.

FIG. 14 illustrates an example of providing connectivity for one or more proximity monitoring systems for multiple trailer combinations for a vehicle.

FIG. 15 schematically illustrates an example of how various embodiments of the invention can leverage pre-existing wires or power cables for transmitting CAN type data communications.

### DESCRIPTION

In developing embodiments of the invention described herein, the inventors have recognized the need to improve driver visibility and awareness. The inventors appreciate that tractor-trailer vehicles must deal with substantial blind spots when moving in reverse and when negotiating tight corners, for example. Accidents involving commercial-scale vehicles can result in significant property damage from the vehicle striking objects or structures in its path, while also creating safety concerns for pedestrians within the vicinity of the vehicle.

The inventors have recognized that traditional monitoring solutions inefficiently require hard-wired installation of video cable, for example, extending the entire length from a rear portion of a trailer to the front of the trailer and/or tractor. Such solutions are labor intensive and expensive, both in terms of labor costs and out-of-service time for the vehicle. The installation typically requires an outdoor location due to the need to access the underside of the trailer, but this situation unfavorably invites problems arising from outdoor conditions (e.g., rain, dust, cold weather, etc.). Traditional solutions also require splicing power from the front of the tractor-trailer to operate components such as a transmitter located at the front of the tractor-trailer. Unfortunately, splicing power can require complex installation techniques and can negatively impact the proper function of the power sources of the tractor-trailer. In addition, transmitter placement at the front of the tractor-trailer is usually necessary in these other solutions due to challenges associated with enabling effective and sufficiently strong wireless communication signals between the rear and the front of the tractor-trailer.

To address these deficiencies in traditional approaches to vehicle proximity monitoring, the inventors have developed a rear-contained monitoring system which employs wireless technology to eliminate the need to extend video cable from the rear to the front of the tractor-trailer. The system can include a universal adapter having an auxiliary connector capable of accessing power at or near the rear of the tractor-trailer. The adapter can have “plug-and-play” compatibility with industry standard seven-way J560 receptacles, for example, which are often located at or near the rear portion of many trailers. Also, the system provides improved wireless communication by employing a transmitter and patch antenna to communicate sufficiently strong and effective signals to an antenna and display monitor near the front of the tractor-trailer.

In other aspects, the inventors have recognized the issues associated with properly pairing a monitoring system positioned on the trailer to a display system located in the tractor. Traditional systems require a specific powering/pairing process and suffer from the potential for pairing to incorrect trailers which could result in a false visual for the driver of the tractor-trailer. For example, multiple tractor-trailers located in close proximity (e.g., a fleet of tractor-trailers warming up in the morning and waiting to depart for the day) could easily and incorrectly wirelessly pair with each other's monitoring systems. To address these issues, embodiments of the present monitoring system can perform the pairing process by leveraging one-to-one wired communication through a DC power line, for example, by sending pairing data between truck and trailer through use of a modulated signal along the DC power line, that could be embodied as Controller Area Network (“CAN”) communication/data protocol, or other data protocol suitable for pairing purposes and functions.

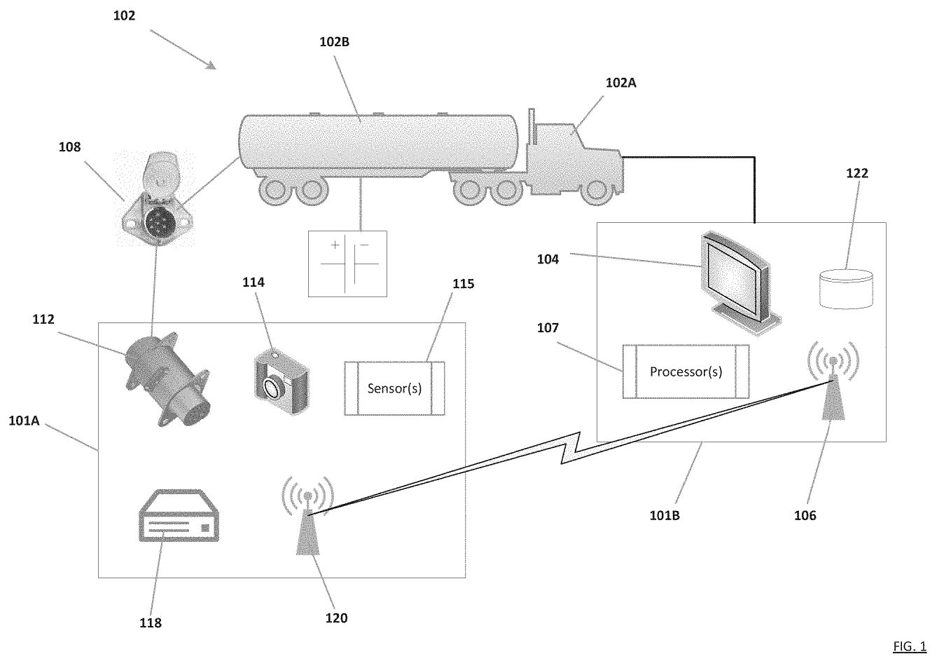

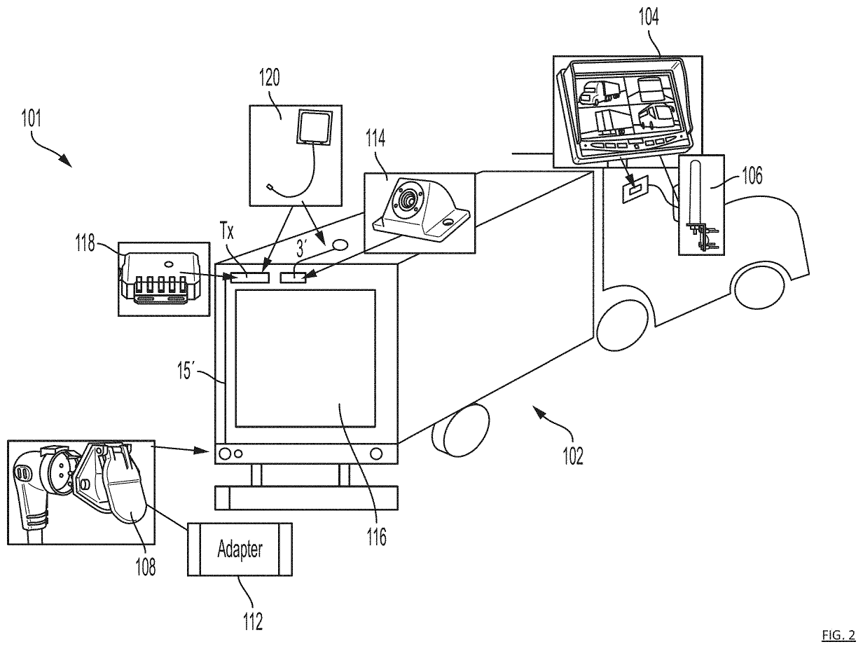

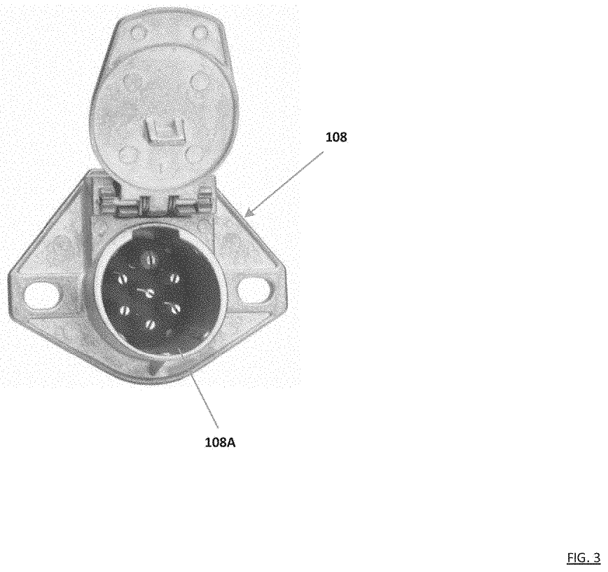

FIGS. 1 and 2 illustrate one example of a vehicle proximity monitoring system 101 structured in accordance with certain embodiments of the present invention. In the example shown, different components of the system 101 may be divided between a proximity detection portion 101A located near the end or back portion of a vehicle 102, for example, and an operator area portion 101B located in the cab or near a front portion of the vehicle 102, for example. In this example, the vehicle 102 comprises a tractor-trailer comprising the combination of a tractor 102A connected to a trailer 102B. In one embodiment, the system 101 may include a display 104 having an operatively associated antenna 106 suitable for receiving wireless-based data communications. One or more computer-implemented processors 107 may be programmed and employed to perform various tasks and execute various functions within the system 101, such as directing various software and hardware functions within the system 101. In certain embodiments, one or more components of the proximity detection portion 101A and/or the operator area portion 101B may have connectivity through a wire-based connection with a CAN bus of the vehicle 102, for example.

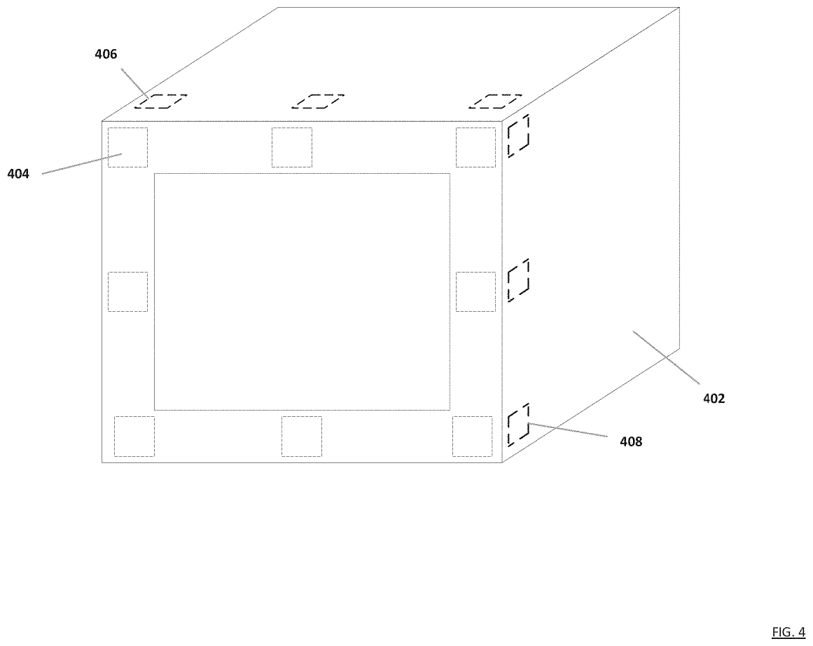

In various embodiments, a receptacle 108 may be positioned near a rear portion of the trailer 102B which may be a seven-way J560 receptacle, for example, structured for facilitating various power supply and data communication functions for the vehicle 102, especially when configured as a tractor-trailer combination, for example. FIG. 3 depicts an enlarged view of the receptacle 108. In accordance with certain embodiments, the system 101 may comprise an adapter 112 (described in more detail below) which is structured to operatively interface with the receptacle 108.

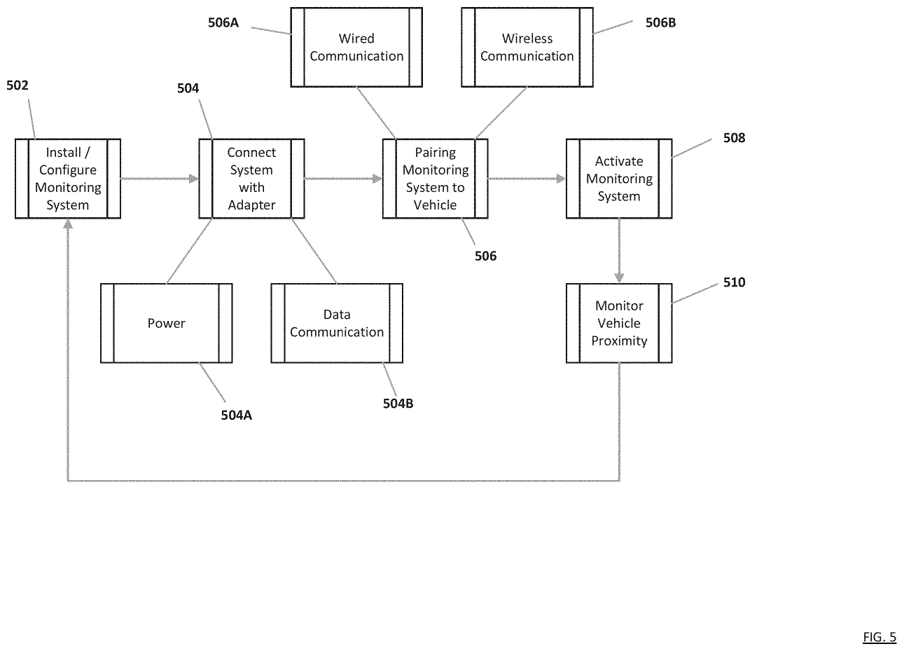

The system 101 may further comprise one or more cameras 114 positioned in a suitable location at the rear portion of the trailer 102B, perhaps near the top margin of the door 116, as shown in this example. In other embodiments, one or more cameras 114 may be positioned at other locations around the rear portion of the trailer 102B. In one embodiment, one or more cameras 114 may be installed within the interior storage space of the trailer 102B, perhaps to monitor the status of products or materials or to deter theft, for example. In certain embodiments, other types of sensors 115 may be employed in place of or in addition to the cameras 114 in various possible combinations. For example, such sensors 115 may be blind spot detection sensors which are enabled by radar, lidar, or sonar techniques and technology. FIG. 4 schematically illustrates a vehicle trailer 402 with multiple locations indicated, e.g., location 404 at the rear end of the trailer 402, location 406 at the top of the trailer 402, and location 408 on the side of the trailer 402, among other potential locations.

In another aspect, a transmitter 118 may be provided to wirelessly communicate data (e.g., video data) captured by the camera 114 to the antenna 106, so that the data can be presented as an image on the display 104. In certain embodiments, the system 101 may further include a patch antenna 120 configured to sufficiently boost the signal communicated by the transmitter 118 to the antenna 106. It can be appreciated that use of the patch antenna 120 may be driven by factors such as the distance between the transmitter 118 and the antenna 106, the amount of signal interference caused by the metal content of the truck 102 itself, and/or other relevant factors. The configuration and installation location of the camera 114, transmitter 118, and/or patch antenna 120 (among other components of the system 101) may be predetermined to maximize available space and minimize physical interference with use of the rear portion of the trailer 102B (e.g., providing sufficient clearance to not interfere with opening and closing of the door 116).

In certain embodiments, a digital video recorder (DVR) 122 or other data storage medium may be provided to store event data for future access and retrieval. Also, one or more other cameras may be installed on different portions of the tractor 102A, for example, such as on the fender or other structural components of the tractor 102A. It can be appreciated that such additional cameras may be hardwired into the systems of the tractor 102 (i.e., versus being configured for wireless communication). Also, such cameras may be accessed during operation of the tractor-trailer 102 to assist a driver with turns, for example, or other vehicle maneuvers.

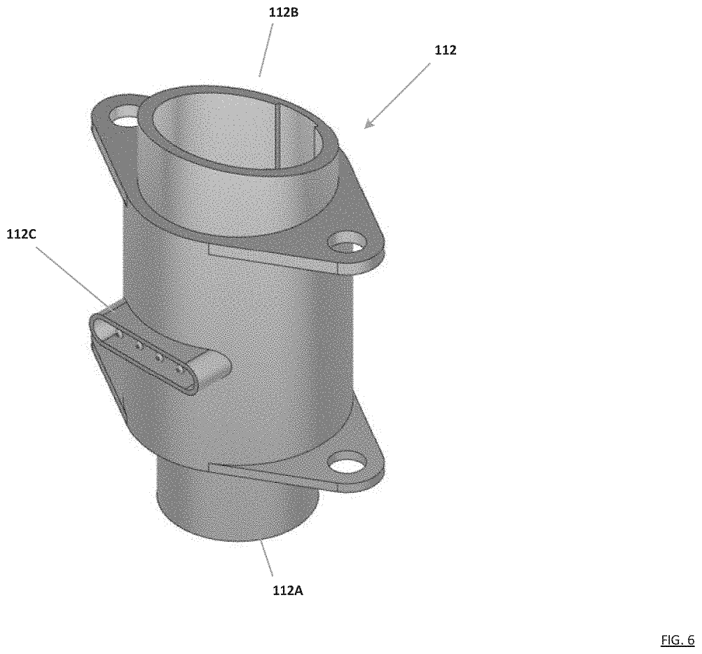

FIG. 5 provides an example of a process flow for installing or configuring the vehicle proximity monitoring system 101 for operation in association with the vehicle 102. At step 502, the various components of the monitoring system 101 can be configured or installed on the vehicle 102 (such as the configuration shown in the example of FIG. 2). At step 504, the system 101 may be connected to the receptacle 108 of the vehicle 102, for example, by using an adapter (such as the examples of the adapter 112 described below). This step facilities providing both power 504A and data communication 504B functionality for the monitoring system 101. At step 506, a paring process is engaged to confirm that the monitoring system 101 is properly operatively associated with the correct vehicle 102. The pairing process at this step 506 may involve establishing wired communication 506A with different vehicle 102 systems, such as through use of the CAN bus functionality of the vehicle 102 (see discussion below). The pairing process may also involve establishing wireless communication 506B between and among different components of the monitoring system 101, such as between the forward portion 101B components and rear portion 101A components of the system 101. Once the system 101 has been paired with the vehicle 102, at step 508 the system 101 may be activated and then begin performing monitoring tasks and functions at step 510. Monitoring tasks may include detecting obstacles, other vehicles, and hazardous conditions in the proximity of the rear of the vehicle 102, for example, when the vehicle is being maneuvered or otherwise in motion.

In various embodiments of the invention, end user directed or instructed behavior is not required to actuate, monitor status, and ensure pairing has been achieved between and among different components of the monitoring system 101. Prior technology has traditionally required end user action for the pairing process, while embodiments of the present system 101 can automatically perform a pairing process. In on example of a pairing process flow involving a tractor-trailer vehicle 102, an operator starts the vehicle 102 and the system 101 executes a routine in which the display 104 is powered, processors 107 are initialized, the system 101 checks for system faults, and the system 101 waits for a signal from one or more of the cameras 114, for example, to begin the pairing process. The operator moves the vehicle 102 to align the tractor 102A to the trailer 102B. The operator then backs up the vehicle 102 to connect the fifth wheel tow pin. The operator then selects neutral or park gear, sets the brake, and then exits the vehicle 102.

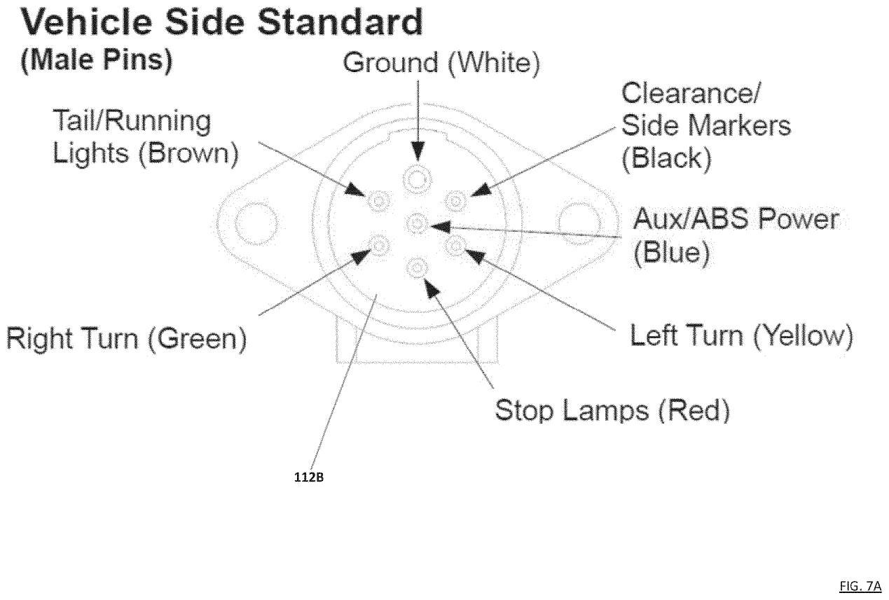

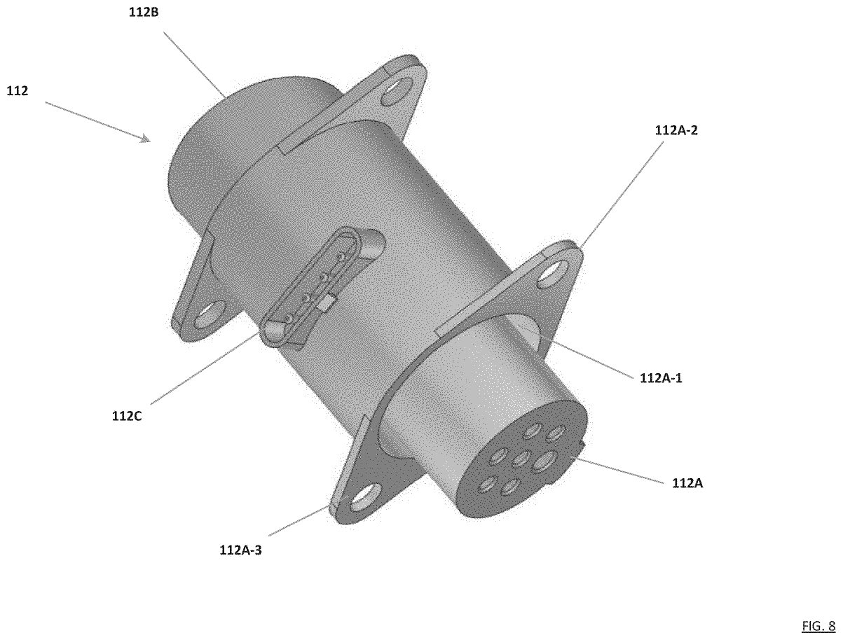

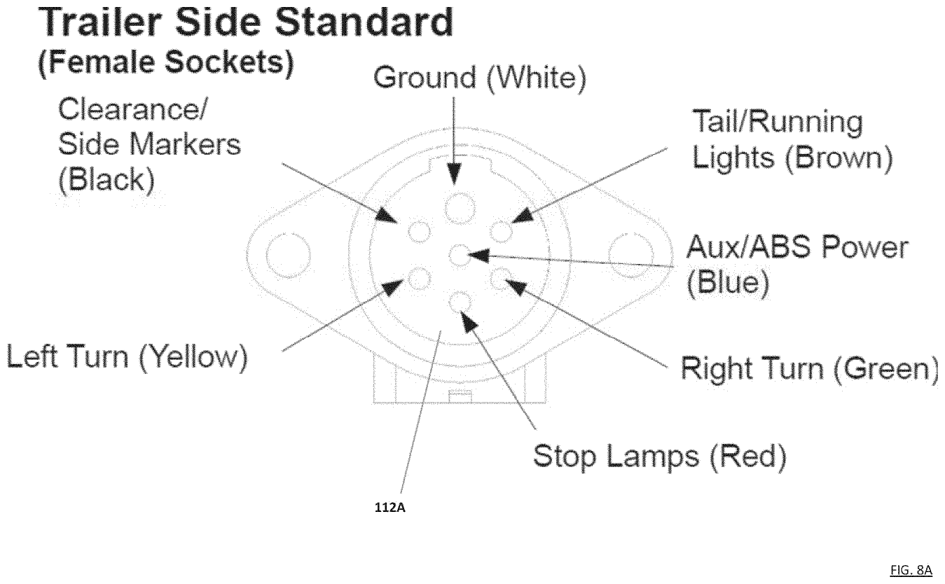

In a next step, the operator raises landing gear associated with the trailer 102B, and connects a seven-way connector for providing power to the trailer 102B from the tractor 102A. At the moment when power is connected to the trailer 102B, the camera 114 is powered and automatically awakened, communication is initialized, fault diagnostics checks occur, and the camera 114 begins sending a message with pair request across the power line to the display 104. In one embodiment, the power line designated for connection “ABS/Aux (Blue)” can be used with return circuit path through the connection designated as “Ground (White)” (see, e.g., FIGS. 7A and 8A). In certain applications, the vehicle's CAN bus 132 may not be available or accessible on the trailer 102B, so the power line is an effective alternative way to perform the pairing process.

At the next stage, the monitor display 104 (which has been awaiting a signal from the camera 114, for example) receives a signal communicated through the power line and establishes pairing. It can be seen that the operator is not required to monitor or take action to perform the paring process. Within a predetermined amount of time (e.g., 10 seconds or less), the pairing process is determined to be either successful or not successful. In both cases, a message advising of paring status can be present to the operator for viewing on the display 104. Once pairing has been established, video signal transmissions then occur wirelessly between the different portions of the system 101.

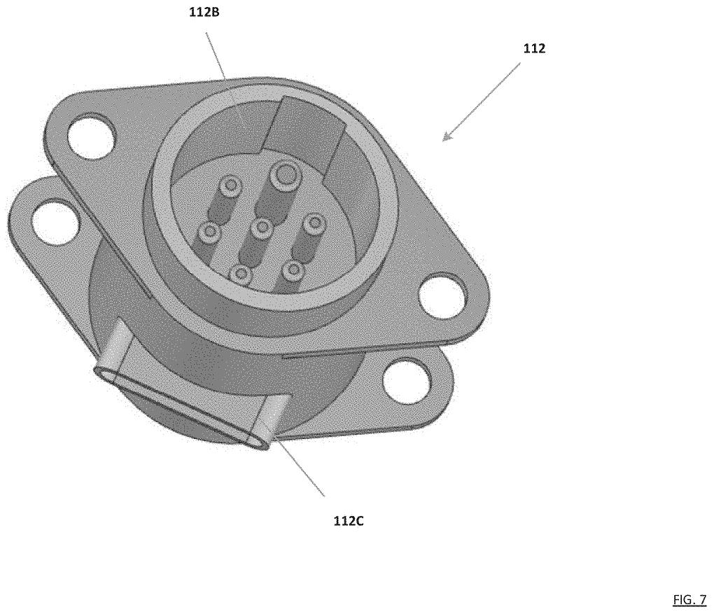

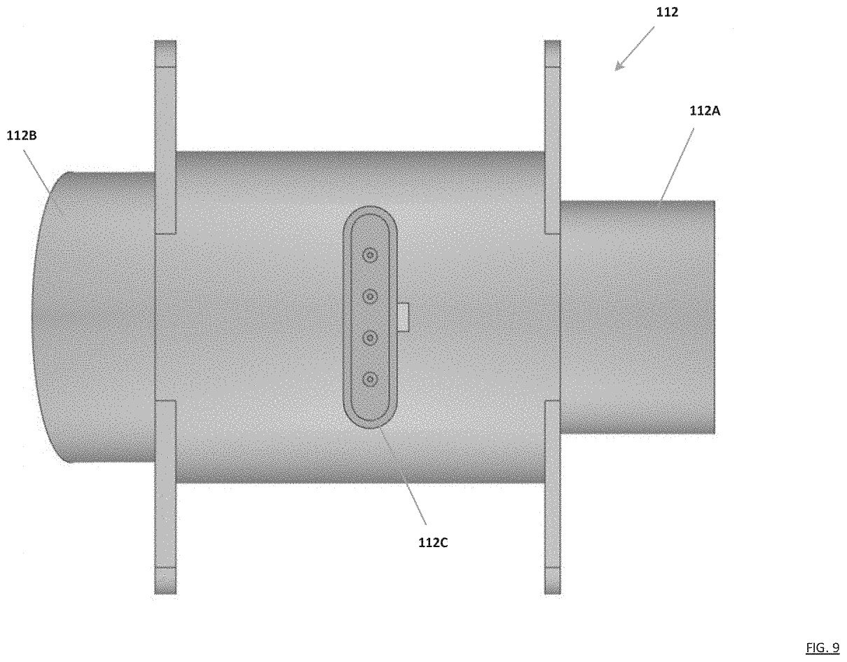

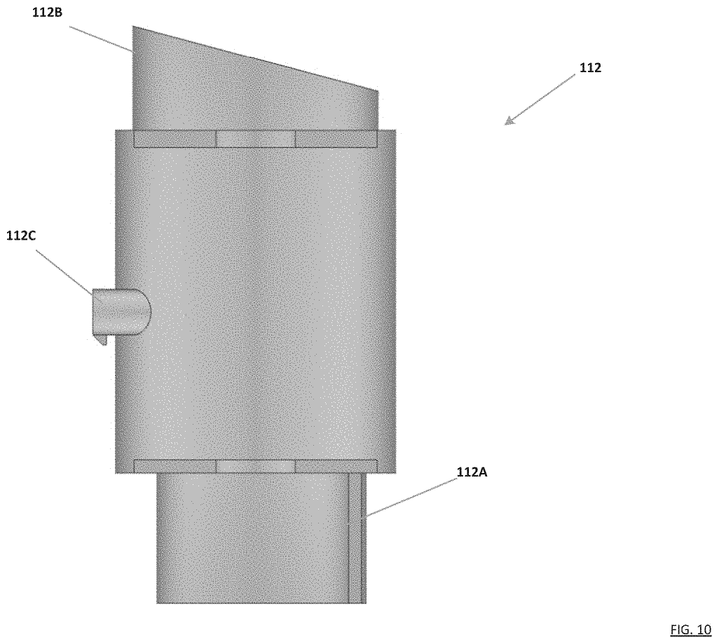

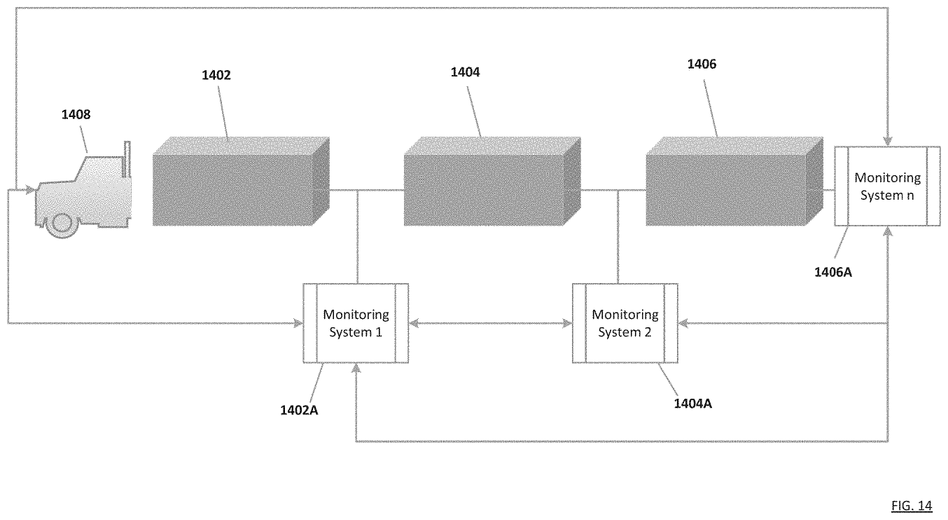

FIGS. 6 through 11 illustrate various views of an example of the adapter 112 of the vehicle proximity monitoring system 101. As shown, a socket portion 112A of the adapter 112 is configured to correspondingly interface with the various pins of the pin portion 108A of the receptacle 108 (see FIG. 3). It can be seen that a cutout portion 112A-1 of the socket portion 112A and flange portions 112A-2, 112A-3 with appropriately sized bolt holes can facilitate secure connection of the socket portion 112A to the pin portion 108A and other corresponding structures of the receptacle 108. It can be appreciated that the connection between the adapter 112 and the receptable 108 allows the system 101 to access various power supply and data communication functions of the tractor-trailer 102. In another aspect, a pin portion 112B of the adapter 112 can be provided to facilitate connection to a receptacle of a successive trailer, such as if the tractor 102A is being used to haul a chain of multiple trailers, for example (see, e.g., FIG. 14).

In one embodiment, a schematic example of a standard vehicle-side receptacle of the adapter 112 is shown in FIG. 7A, including the various vehicle 102 functions corresponding to each of its male connection pins structured for interfacing with the receptacle 108. Non-limiting examples of these functions include directing the action of various lights of the vehicle 102 and/or supplying power to different components of the vehicle 102, as shown. Likewise, in another embodiment, a schematic example of a standard trailer-side receptacle is shown in FIG. 8A, including the various functions provided by each of its female connection sockets. Non-limiting examples of these functions include directing the action of various lights of the vehicle 102 and/or supplying power to different components of the vehicle 102, as shown.

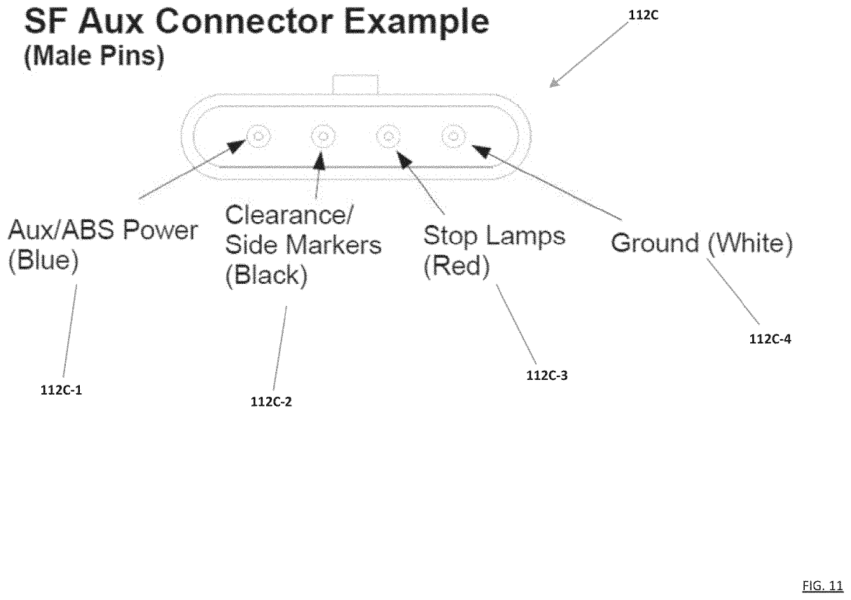

In various embodiments, the adapter 112 may be provided with an auxiliary connector 112C which includes various pins that enable different power supply and data communication functions for the monitoring system 101. In the schematic depiction of the auxiliary connector 112C shown in FIG. 11, four pins 112C-1 through 112C-4 provide connection between the monitoring system 101 and the data communication capabilities and power sources of the tractor-trailer 102. For example, pin 112C-1 can be used to supply power to the system 101. In another example, pin 112C-2 can be used for data communications involving accessing a DC power line (as described above). In certain embodiments, the auxiliary connector 112C may have as few as two pins or more than four pins as determined by a particular application involving specific data communication or power supply requirements of the monitoring system 101, for example.

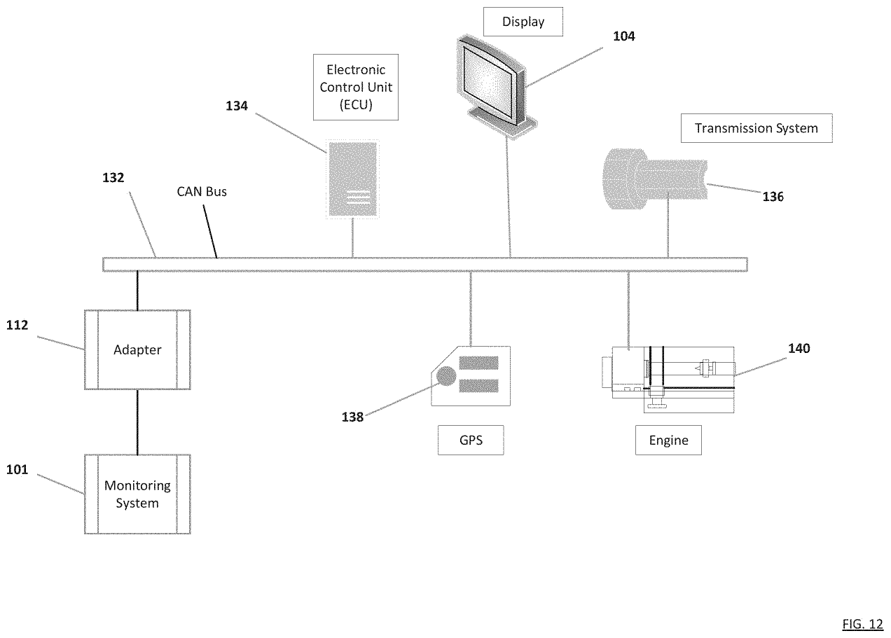

It can be seen that the adapter 112 can be embodied as a substantially sealed, molded unit which offers an effective way to tap into the data communication and power supply capabilities of the other systems of the tractor-trailer 102. For example, the need for labor intensive wiring and splicing is significantly reduced by providing access and connection through the auxiliary connector 112C. FIG. 12 illustrates an example of the how the adapter 112 can facilitate connection between the monitoring system 101 and a CAN bus 132 of the tractor-trailer 102. As shown, the CAN bus 132 facilitates communications between and among different components of the tractor-trailer 102 (e.g., the display 104, an ECU 134, a transmission system 136, a GPS system 138, and an engine 140, among other components). It can be appreciated that using the existing CAN bus 132 provides new possibilities for data communication, such as pairing information between the display 104 and the monitoring system 101, for example, without interfering with other important data flow tasks executed by the CAN bus 132.

In another embodiment, the pairing process between the display 104 and the monitoring system 101 might be accomplished by wireless communication by designating a unique identifier or number for each system 101. This information can be transmitted and presented as a list of available unique identifiers on the display 104, for example, for manual inspection of the list during the pairing process. In this manner, guidance can be provided for selecting which system 101 will be paired to which display 104 to promote displaying accurate visual information to a driver of the tractor-trailer 102.

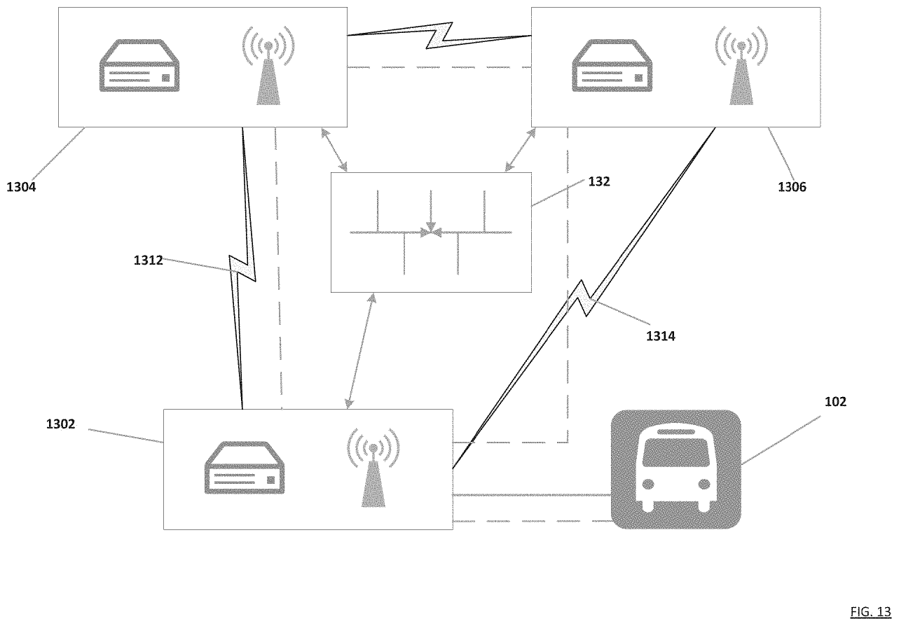

With reference to FIG. 13, the inventors have acknowledged that pairing of wireless-enabled (radio frequency) devices 1302, 1304, 1306 can be implemented beyond the video and sensor applications included as examples herein. In certain applications, data to be transmitted may be too dense for communication over power (e.g., with a CAN bus 132 of a vehicle 102) and therefore a wireless communication is more effective. In parallel, there are instances when a one-to-many relationship exists among different wireless-enabled devices 1302, 1304, 1306, and so the hardwire pairing (e.g., through the CAN bus 132) is a key feature in those situations. In the example shown in FIG. 13, the wireless-enabled devices 1304, 1306 are equipped for both wired communication through the CAN bus 132 as well as wireless communication through connections 1312, 1314. In addition, the devices 1302, 1304, 1306 can be configured to established data communication connections between or among each other through one or more existing power lines, such as power cables or wires (represented by dashed lines as shown in FIG. 13). In various embodiments, the wireless-enabled devices 1302, 1304, 1306 may be, for example and without limitation, displays, mobile phones, servers, laptops, and/or a variety of other computing devices or appliances.

With reference to FIG. 14, it can be seen that various embodiments or variations of the adapter 112 can provide connectivity for multiple trailer combinations 1402, 1404, 1406 connected in series. In this example, each trailer 1402, 1404, 1406, includes a corresponding, operatively associate monitoring system 1402A, 1404A, 1406A, each of which may communicate with each other and/or with a front potion of the system 1402A, 1404A, 1406A, located in an operator area 408 of the vehicle. In an alternative embodiment, only one monitoring system 1406A is implemented at the last trailer 1406 in the series, and the system 1406A is connected chain-wise through the receptacles, for example, of the other trailers 1402, 1404.

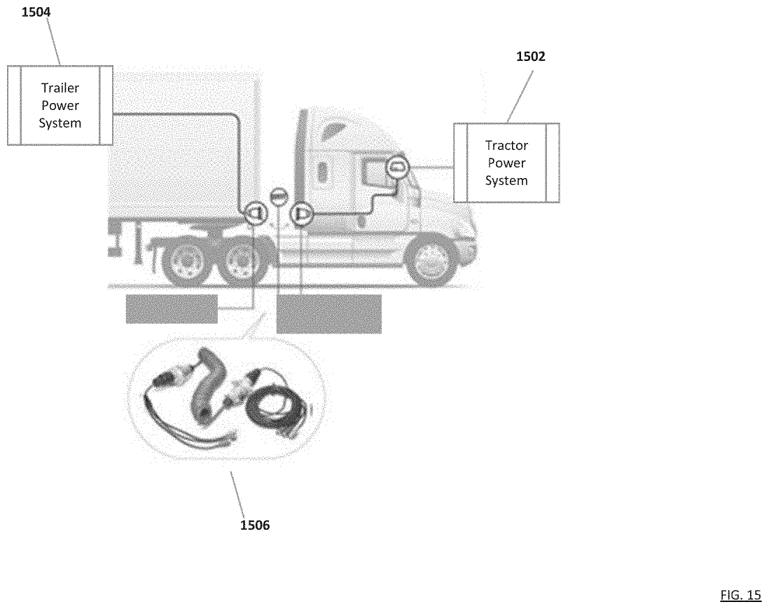

FIG. 15 schematically illustrates an example of how various embodiments of the invention can leverage pre-existing power cables for transmitting the equivalent of CAN-type data communications. In the case of a tractor-trailer combination, for example, such embodiments might leverage connections between a tractor power system 1502 and a trailer power system 1504. Also, the existing cable and wiring connections for a quick-connect harness 1506 between the power systems 1502, 1504 may be used. Those skilled in the art will appreciate the value in reducing or eliminating the need to install one or more dedicated cables to facilitate data communication between devices on both new vehicle builds as well as for retrofitting vehicles already employed on existing fleets. In this arrangement, different components of a monitoring system, for example, can be paired using existing power cables and power systems of the vehicle.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, configurations, data definitions, or process flows described herein are necessarily intended to limit the scope of the invention, unless such aspects are specifically claimed as such.

Any element expressed herein as a means for performing a specified function is intended to encompass any way of performing that function including, for example, a combination of elements that performs that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

The processes associated with the present embodiments may be executed by programmable equipment, such as computers. Software or other sets of instructions that may be employed to cause programmable equipment to execute the processes may be stored in any storage device, such as a computer system (non-volatile) memory. Furthermore, some of the processes may be programmed when the computer system is manufactured or via a computer-readable memory storage medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. Memory and/or storage components may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, digital video recorders (DVR), RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

A “computer,” “computer system,” “computing apparatus,” “component,” or “computer processor” may be, for example and without limitation, a processor, microcomputer, minicomputer, server, mainframe, laptop, personal data assistant (PDA), wireless e-mail device, smart phone, mobile phone, electronic tablet, cellular phone, pager, fax machine, scanner, or any other programmable device or computer apparatus configured to transmit, process, and/or receive data. Computer systems and computer-based devices disclosed herein may include memory and/or storage components for storing certain software applications used in obtaining, processing, and communicating information. It can be appreciated that such memory may be internal or external with respect to operation of the disclosed embodiments. In various embodiments, a “host,” “engine,” “loader,” “filter,” “platform,” or “component” may include various computers or computer systems, or may include a reasonable combination of software, firmware, and/or hardware. In certain embodiments, a “module” may include software, firmware, hardware, or any reasonable combination thereof.

In various embodiments of the present invention, a single component may be replaced by multiple components, and multiple components may be replaced by a single component, to perform a given function or functions.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. Wireless communications described herein may be conducted with Wi-Fi and Bluetooth enabled networks and devices, among other types of suitable wireless communication protocols. For vehicle systems, networks such as CAN or J1939 may be employed, for example. For V2I (vehicle to infrastructure), or V2X (vehicle to everything) communications, technology such as DSRC or 3GPP may be used, for example. The Controller Area Network (CAN) bus is a serial bus protocol to connect individual systems and sensors as an alternative to conventional multi-wire looms. In certain cases, the CAN bus protocol allows vehicle components to communicate on a single or dual-wire networked data bus. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to-country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the wireless device to the network. The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. Discrete components and features may be readily separated from or combined with the features of any of the other several aspects without departing from the scope of the present disclosure. Any recited method can be carried out in the order of events recited or in any other order which is logically possible.

Unless specifically stated otherwise, it may be appreciated that terms such as “processing,” “computing,” “calculating,” “determining,” or the like, refer to the action and/or processes of a computer or computing system, or similar electronic computing device, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

Certain embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

The flow charts and methods described herein show the functionality and operation of various implementations. If embodied in software, each block, step, or action may represent a module, segment, or portion of code that comprises program instructions to implement the specified logical functions. The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical functions.

Reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment. The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as” or “for example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as claimed herein.

What is claimed is:

1. A vehicle proximity monitoring system comprising:
an operator area portion comprising:
a computer processor programmed for receiving and processing both wireless-based data communications and wire-based data communications; and
a proximity detection portion comprising:
at least one condition monitoring device,
an antenna for wirelessly transmitting data collected by the condition monitoring device to the operator area portion, and
wherein the proximity detection portion is configured for data communication with:
a controller area network (CAN) bus operatively associated with the vehicle, and
a power line of the vehicle for pairing at least one component of the proximity detection portion with at least one component of the operator area portion.

2. The system of claim 1, further comprising the proximity detection portion configured for communicating data through the CAN bus to the processor of the operator area portion.

3. The system of claim 1, wherein the operator area portion further comprises at least least one display for displaying data communicated from the condition monitoring device.

4. The system of claim 3, wherein the condition monitoring device comprises at least one camera programmed for generating video data associated with a proximity of the vehicle.

5. The system of claim 3, wherein the condition monitoring device comprises at least one sensor programmed for generating data associated with a proximity of the vehicle.

6. The system of claim 5, wherein the sensor is programmed for using at least one of or a combination of sonar, radar, or lidar for generating data associated with a proximity of the vehicle.

7. The system of claim 1, wherein the vehicle comprises a tractor-trailer combination.

8. The system of claim 1, wherein the vehicle comprises a tractor and multiple trailers, and the proximity detection portion is positioned on the trailer most distally located from the operator area portion.

9. The system of claim 1, wherein the vehicle comprises a tractor and multiple trailers, and further comprising at least one additional monitoring system operatively associated with at least one of the multiple trailers.

10. The system of claim 1, further comprising an adapter configured for establishing at least one data communication connection between at least one receptacle of the vehicle and the proximity detection portion.

11. The system of claim 1, further comprising the adapter configured for interfacing the proximity detection portion with at least one data communication function of the vehicle.

12. The system of claim 1, further comprising the adapter configured for interfacing the proximity detection portion with at least one power function of the vehicle.

13. The system of claim 1, further comprising a patch antenna configured to boost a signal wirelessly communicated by the proximity detection portion to the operator area portion.

14. The system of claim 1, wherein the operator area portion further comprises a data storage medium for storing event data associated with data received from the condition monitoring device.

15. The system of claim 1, further comprising the operator area portion configured for wirelessly pairing with the proximity detection portion.

16. The system of claim 1, further comprising the operator area portion configured for pairing with the proximity detection portion via a CAN bus connection.

17. The system of claim 1, further comprising the proximity detection portion configured for connecting to a global positioning system of the vehicle via the CAN bus connection.

18. The system of claim 1, further comprising the proximity detection portion configured for connecting to an electronic control unit of the vehicle via the CAN bus connection.

19. The system of claim 1, further comprising:
the operator area portion including a display for displaying data communicated from the condition monitoring device; and
the proximity detection portion configured for connecting to the display via the CAN bus connection.

20. A communication system for wireless-enabled devices, the system comprising:
a first wireless-enabled device; and
at least a second wireless-enable device configured for data connectivity with the first wireless-enable device through at least connections comprising:
a wireless-based data communication connection,
a wire-based data communication connection through a controller area network (CAN) bus, and
a wire-based data communication connection through at least one power line.

21. The system of claim 20, wherein the CAN bus is operatively associated with a vehicle.
